(19) United States
(12) Patent Application Publication
(10) Pub. No.: US 2019/0302656 A1
(43) Pub. Date: Oct. 3, 2019

(54) IMAGE FORMING APPARATUS

(71) Applicant: CANON KABUSHIKI KAISHA, Tokyo (JP)

(72) Inventors: Keisuke Ishizumi, Hiratsuka-shi (JP); Shohei Ishio, Tokyo (JP); Takayuki Tanaka, Tokyo (JP); Hiroomi Kojima, Yokohama-shi (JP)

(21) Appl. No.: 16/365,325

(22) Filed: Mar. 26, 2019

(30) Foreign Application Priority Data
Mar. 30, 2018 (JP) 2018-068245
Feb. 6, 2019 (JP) 2019-019539

(51) Int. Cl. G03G 15/16; G03G 15/00

(52) U.S. Cl. CPC G03G 15/1615; G03G 15/162; G03G 2215/1661; G03G 15/5058; G03G 2215/00059; G03G 15/161

(57) ABSTRACT

A detection unit executes correction control of an image formation condition on a basis of a detection result of reflected light when infrared light is radiated to a test patch, which is transferred from a photosensitive drum to an intermediate transfer belt, and the intermediate transfer belt, wherein the intermediate transfer belt has a base layer which is thickest among a plurality of layers forming the intermediate transfer belt in a thickness direction of the intermediate transfer belt and to which an ion conductive agent is added, and an inner surface layer which has a light transmittance lower than that of the base layer.

### BACKGROUND

### Field of the Disclosure

The present disclosure relates to an electrophotographic image forming apparatus such as a copier or a printer.

### Description of the Related Art

As an electrophotographic image forming apparatus, a tandem-type image forming apparatus that has a configuration in which a plurality of image forming units are arranged in a movement direction of a belt such as a conveyance belt or an intermediate transfer belt is known. Each of the image forming units for respective colors includes a photosensitive member (hereinafter, referred to as a photosensitive drum) of a drum shape serving as an image bearing member. Toner images of the respective colors borne by corresponding photosensitive drums of the respective colors are transferred to a transfer material, such as paper or an OHP sheet, which is conveyed by a transfer material conveyance belt, or are transferred to the transfer material after being transferred to the intermediate transfer belt once, and then fixed to the transfer material by a fixing unit.

In the electrophotographic image forming apparatus, due to a change in a condition of an installation environment of the apparatus, a change of a photosensitive drum or toner over time, a temperature change in the apparatus, or the like, an image formation condition such as a position or density of an image to be formed may vary. Thus, there is a case where correction control is performed in such a manner that reflected light from a toner image (hereinafter, referred to as detection toner) for detection that is transferred from a photosensitive drum to a belt and reflected light from the belt are detected by a detection unit such as an optical sensor and the image formation condition is corrected on the basis of a result of the detection. More specifically, in such correction control, by utilizing specularly-reflected light from the belt and diffused reflected light from the detection toner, information about a position or density of the detection toner is acquired and fed back to the correction of the image formation condition such as the position or density of the image.

As the belt used for the image forming apparatus, a member obtained by adding an electronically conductive agent such as carbon or an ionically conductive agent (hereinafter, referred to as an ion conductive agent) such as ionically conductive polymer to base resin as a substrate of the belt to adjust an electrical resistance value is widely known. Here, since the belt obtained by adding the ion conductive agent has high transparency, light from a light source is transmitted through the belt, so that erroneous detection by the detection unit may be caused when the correction control described above is performed. Against such a problem, Japanese Patent Laid-Open No. 2002-265642 discloses a configuration of a belt whose light transmittance is able to be appropriately controlled by adding a coloring agent.

In the configuration of Japanese Patent Laid-Open No. 2002-265642, however, since a dispersed state of the coloring agent affects distribution of resistance of the belt, when uniformity of an electrical resistance value of the belt is deteriorated, it may be difficult to ensure stable transferability.

### SUMMARY

Thus, in the subject disclosure, an image forming apparatus that detects reflected light of light radiated to a belt and performs correction control related to an image, erroneous detection in the correction control is suppressed while stable transferability is ensured.

The disclosure provides an image forming apparatus including: an image bearing member configured to bear a toner image; a movable belt that is configured of a plurality of layers and contacts the image bearing member; a detection unit configured to detect reflected light from the belt and a detection toner image when light is radiated to the detection toner image, which is transferred from the image bearing member to the belt, and the belt; and a control unit configured to execute, on a basis of a detection result of the detection unit, correction control of an image formation condition of an image formed by the toner image, in which the plurality of layers of the belt include a first layer that has a first light transmittance and is a thickest layer out of the plurality of layers making up the belt with respect to a thickness direction of the belt and to which an ion conductive agent is added, and a second layer which has a second light transmittance lower than the first light transmittance.

Further features of the present disclosure will become apparent from the following description of exemplary embodiments with reference to the attached drawings.

### BRIEF DESCRIPTION OF THE DRAWINGS

FIG. 1 is a schematic sectional view of a configuration of an image forming apparatus, according to one or more embodiment of the subject disclosure.

FIG. 2 is a control block diagram of an image forming apparatus, according to one embodiment of the subject disclosure.

FIGS. 3A to 3C are schematic views for explaining arrangement and a configuration of a detection unit, according to one or more embodiment of the subject disclosure.

FIG. 4 is a schematic view of a detection toner image when correction control to correct a position of an image is executed, according to one or more embodiment of the subject disclosure.

FIG. 5 is a schematic view of a configuration of an intermediate transfer belt, according to one or more embodiment of the subject disclosure.

FIG. 6 is a table for explaining a light transmittance of an intermediate transfer belt, according to one or more embodiment of the subject disclosure and a comparative example 1.

FIGS. 7A and 7B are graphs each indicating a detection result by the detection unit in, according to one or more embodiment of the subject disclosure and the comparative example 1.

FIGS. 8A and 8B are schematic views for respectively explaining reflection of infrared light radiated to the intermediate transfer belt, according to one or more embodiment of the subject disclosure and the comparative example 1.

FIGS. 9A and 9B are schematic views for respectively explaining reflection of infrared light radiated to a detection toner image, according to one or more embodiment of the subject disclosure and the comparative example 1.

FIG. 10 is a schematic view of a detection toner image when correction control to correct a density of an image is executed, according to one or more embodiment of the subject disclosure.

FIGS. 11A and 11B respectively illustrate a detection result of a detection toner image when correction control to correct a density of an image is executed, according to one or more embodiment of the subject disclosure and the comparative example 1.

FIG. 12 is a schematic view of a configuration of an intermediate transfer belt, according to one or more embodiment of the subject disclosure.

FIG. 13 is a graph for explaining wavelength distribution of a light emitting element that has distribution in a wavelength region.

FIG. 14 is a graph for explaining a relationship between an addition amount of a coloring agent and a transmittance of infrared light, according to one or more embodiment of the subject disclosure.

FIGS. 15A and 15B are schematic views of a configuration of an intermediate transfer belt, according to one or more embodiment of the subject disclosure.

FIG. 16 is a schematic view of reflected light from the intermediate transfer belt, according to one or more embodiment of the subject disclosure.

FIGS. 17A and 17B are graphs each indicating a detection result by the detection unit, according to one or more embodiment of the subject disclosure and a comparative example 2.

### DESCRIPTION OF THE EMBODIMENTS

Desirable exemplary embodiments of the disclosure will be exemplarily described in detail below with reference to the drawings. Note that, dimensions, materials, shapes, and relative arrangement of components described in the following exemplary embodiments are to be appropriately changed in accordance with a configuration of an apparatus to which the disclosure is applied and various conditions. Thus, a scope of the disclosure is not intended to be limited only to the following exemplary embodiments, unless otherwise specifically stated.

### Exemplary Embodiment 1

### [Explanation of Image Forming Apparatus]

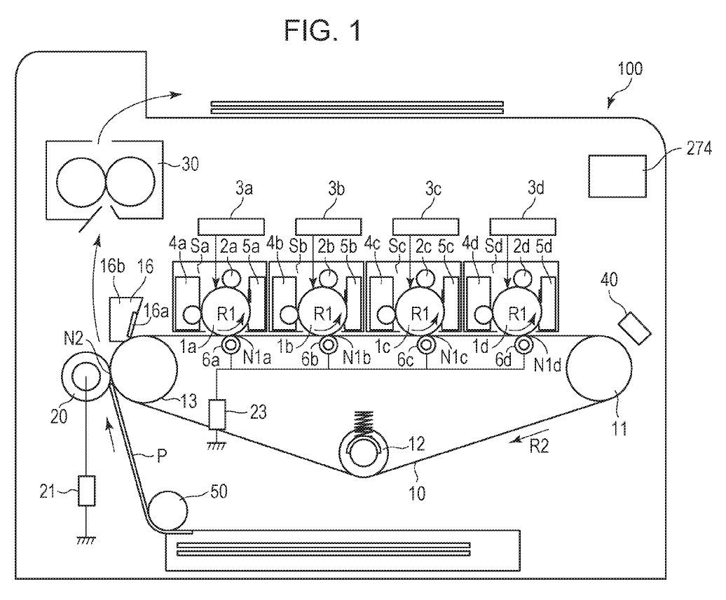

FIG. 1 is a schematic sectional view illustrating a configuration of an image forming apparatus 100 of the present exemplary embodiment. Note that, the image forming apparatus 100 of the present exemplary embodiment is a so-called tandem-type image forming apparatus including a plurality of image forming units Sa to Sd. The first image forming unit Sa, the second image forming unit Sb, the third image forming unit Sc. and the fourth image forming unit Sd form images with toner of colors of yellow (Y), magenta (M), cyan (C), and black (Bk), respectively. The four image forming units are arranged in a row with a certain interval, and configurations of the image forming units are practically common to each other in many parts except for colors of the toner contained therein. Accordingly, the image forming apparatus 100 of the present exemplary embodiment will be described below with reference to the first image forming unit Sa.

The first image forming unit Sa includes a photosensitive drum 1a serving as a photosensitive member of a drum shape, a charging roller 2a serving as a charging member, a development unit 4a, and a drum cleaning unit 5a.

The photosensitive drum 1a is an image bearing member that bears a toner image and rotationally driven in a direction indicated by an arrow R1 in FIG. 1 at a predetermined circumferential speed (process speed). The development unit 4a contains yellow toner, and develops a yellow toner image on the photosensitive drum 1a. The drum cleaning unit 5a is a unit that collects toner bonded to the photosensitive drum 1a. The drum cleaning unit 5a includes a cleaning blade that contacts the photosensitive drum 1a and a waste toner box that contains, for example, toner removed from the photosensitive drum 1a by the cleaning blade.

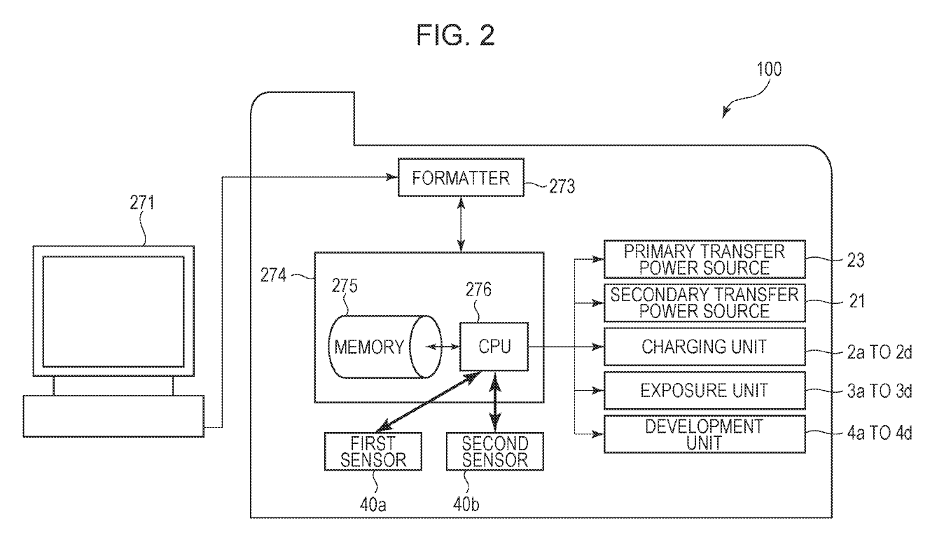

When an image forming operation starts upon reception of an image signal by a controller 274 (illustrated in FIG. 2) as a control unit, the photosensitive drum 1a is rotationally driven. In the course of rotation, the photosensitive drum 1a is uniformly charged with a predetermined potential (charging potential) in a predetermined polarity (in the present exemplary embodiment, a negative polarity) by the charging roller 2a, and exposed to light according to the image signal by the exposure unit 3a. Thereby, an electrostatic latent image corresponding to a yellow color component image of a target color image is formed. Then, the electrostatic latent image is developed by the development unit 4a at a development position and visualized as a yellow toner image (hereinafter, simply referred to as a toner image). Here, a regular charging polarity of the toner contained in the development unit 4a is a negative polarity. In the present exemplary embodiment, the electrostatic latent image is reversely developed with toner charged in a polarity that is the same as the charging polarity of the photosensitive drum 1a charged by the charging member, however, the disclosure is also applicable to an image forming apparatus that positively develops the electrostatic latent image with toner charged in a polarity opposite to the charging polarity of the photosensitive drum 1a.

An intermediate transfer belt 10 as an intermediate transfer body that is endless and movable is arranged at a position contacting photosensitive drums 1a to 1d of the image forming units Sa to Sd and is stretched around three rollers, i.e., a support roller 11, a stretching roller 12, and a facing roller 13 that are stretching members. The intermediate transfer belt 10 is an endless belt made of a resin material to which electrical conductivity is provided by adding a conductive agent and which has a circumferential length of 700 mm, and is stretched with a tensile force of a total pressure of 60 N applied by the stretching roller 12 and moves in a direction indicated by an arrow R2 in FIG. 1 due to rotation of the facing roller 13 that rotates by receiving a driving force. Note that, the intermediate transfer belt 10 in the present exemplary embodiment is constituted by a plurality of layers, and details thereof will be described below.

In the present exemplary embodiment, a sleeve made of stainless steel (SUS) is used as the support roller 11 and the stretching roller 12 and outer diameters of the support roller 11 and the stretching roller 12 are respectively 24 mm and 12 mm. As the facing roller 13, a roller that is obtained by covering a sleeve made of stainless steel (SUS) having an outer diameter of 23 mm with ethylene propylene diene rubber (EPDM) having a thickness of 500 μm and that is adjusted to have an electrical resistance value of 1×10⁵Ω or less is used. Note that, as in the present exemplary embodiment, when a roller made of a metal member that is not covered with a rubber member is used as the support roller 11 and the stretching roller 12, it is possible to achieve cost reduction of a member.

The toner image formed on the photosensitive drum 1a is primarily-transferred to the intermediate transfer belt 10 upon application of a voltage with a positive polarity from a primary transfer power source 23 to a primary transfer roller 6a while the toner image passes through a primary transfer portion N1a at which the photosensitive drum 1a contacts the intermediate transfer belt 10. After that, toner that is not primarily-transferred to the intermediate transfer belt 10 and remains on the photosensitive drum 1a is collected by the drum cleaning unit 5a and thereby removed from a surface of the photosensitive drum 1a.

Here, the primary transfer roller 6a is a primary transfer member (contact member) that is provided at a position corresponding to the photosensitive drum 1a via the intermediate transfer belt 10 and contacts an inner circumferential surface of the intermediate transfer belt 10. The primary transfer power source 23 is a power source that is able to apply a voltage with a positive polarity or a negative polarity to primary transfer rollers 6a to 6d. A configuration in which the common primary transfer power source 23 applies the voltage to a plurality of primary transfer members will be described in the present exemplary embodiment, but the disclosure is not limited thereto and is also applicable to a configuration in which a plurality of primary transfer power sources are provided correspondingly to the respective primary transfer members.

Subsequently, in a similar manner, a magenta toner image of a second color, a cyan toner image of a third color, and a black toner image of a fourth color are formed and sequentially overlapped and transferred to the intermediate transfer belt 10. Thereby, the toner images of the four colors corresponding to a target color image are formed on the intermediate transfer belt 10. Then, the toner images of the four colors borne by the intermediate transfer belt 10 are collectively secondarily-transferred to a surface of a transfer material P, such as paper or an OHP sheet, which is fed by a feeding unit 50, while passing through a secondary transfer portion formed by a secondary transfer roller 20 and the intermediate transfer belt 10 contacting with each other.

The secondary transfer roller 20 has an outer diameter of 18 mm and is obtained by covering a nickel plated steel bar having an outer diameter of 6 mm with a foamed sponge body that is mainly made of NBR and epichlorohydrin rubber and is adjusted to have a volume resistivity of 10⁸ Ω·cm and a thickness of 6 mm. Note that, the formed sponge body has a rubber hardness of 30° when measurement is executed by using an Asker-C hardness meter at a weight of 500 g. The secondary transfer roller 20 is in contact with an outer circumferential surface of the intermediate transfer belt 10, and is pressed against the facing roller 13, which is arranged at a position facing the secondary transfer roller 20 via the intermediate transfer belt 10, at a pressure force of 50 N to form a secondary transfer portion N2.

The secondary transfer roller 20 is driven to rotate along with the intermediate transfer belt 10, and when a voltage is applied thereto from a secondary transfer power source 21, a current flows to the facing roller 13 from the secondary transfer roller 20. Thereby, the toner image borne by the intermediate transfer belt 10 is secondarily-transferred to the transfer material P at the secondary transfer portion N2. Note that, when the toner image on the intermediate transfer belt 10 is secondarily-transferred to the transfer material P, the voltage applied to the secondary transfer roller 20 from the secondary transfer power source 21 is controlled so that the current flowing to the facing roller 13 from the secondary transfer roller 20 via the intermediate transfer belt 10 becomes constant. In addition, an amount of the current for performing the secondary transfer is decided in advance in accordance with a surrounding environment in which the image forming apparatus 100 is installed or a type of the transfer material P. The secondary transfer power source 21 is connected to the secondary transfer roller 20 and applies a transfer voltage to the secondary transfer roller 20. Further, the secondary transfer power source 21 is able to output the voltage in a range from 100 V to 4000 V.

Then, the transfer material P to which the toner images of the four colors are transferred through the secondary transfer is heated and pressurized by a fixing unit 30, so that the toner of the four colors is fused and mixed and fixed to the transfer material P. The toner remaining on the intermediate transfer belt 10 after the secondary transfer is cleaned and removed by a belt cleaning unit 16 that is provided so as to face the facing roller 13 via the intermediate transfer belt 10. The belt cleaning unit 16 includes a cleaning blade 16a (cleaning member) that contacts the outer circumferential surface of the intermediate transfer belt 10 at a position where the belt cleaning unit 16 faces the facing roller 13 and a residual toner container 16b that contains the toner collected by the cleaning blade 16a.

Through the operation described above, the image forming apparatus 100 of the present exemplary embodiment forms a full-color printed image.

### [Explanation of Control Block Diagram]

FIG. 2 is a control block diagram illustrating control of the image forming operation in the image forming apparatus 100. A personal computer 271 as a host device issues an instruction to start image formation to a formatter 273 in the image forming apparatus 100 and transmits data of an image to be formed to the formatter 273. The formatter 273 converts the image data transmitted from the personal computer 271 into exposure data and transfers the resultant to the controller 274 as a control unit. The controller 274 is provided with a CPU 276, a memory 275, and the like and is able to perform a preprogrammed operation. Upon reception of the instruction to start image formation from the formatter 273, the CPU 276 provided in the controller 274 controls the respective units, so that the image forming operation is performed.

The CPU 276 also performs processing of receiving signals from a first sensor 40a and a second sensor 40b, which are provided in a detection unit 40, when correction control to correct an image formation condition such as a position or density of an image to be formed in the image forming apparatus 100 is executed. In the correction control of the image formation condition, a quantity of reflected light from the outer circumferential surface of the intermediate transfer belt 10 at a position facing the detection unit 40 or a test patch (detection toner image) formed on the intermediate transfer belt 10 is measured. The detection signals by the first sensor 40a and the second sensor 40b are subjected to AD conversion via the CPU 276 and then stored in the memory 275. The controller 274 performs calculation by using detection results by the first sensor 40a and the second sensor 40b to perform various kinds of correction.

### [Detection Unit]

Next, the detection unit 40 will be described. The detection unit 40 detects reflected light from the outer circumferential surface of the intermediate transfer belt 10 and the test patch formed on the intermediate transfer belt 10. Here, the test patch is specifically a positional deviation control pattern for detecting a deviation of a position where an image is formed or a density control pattern for detecting a density of an image.

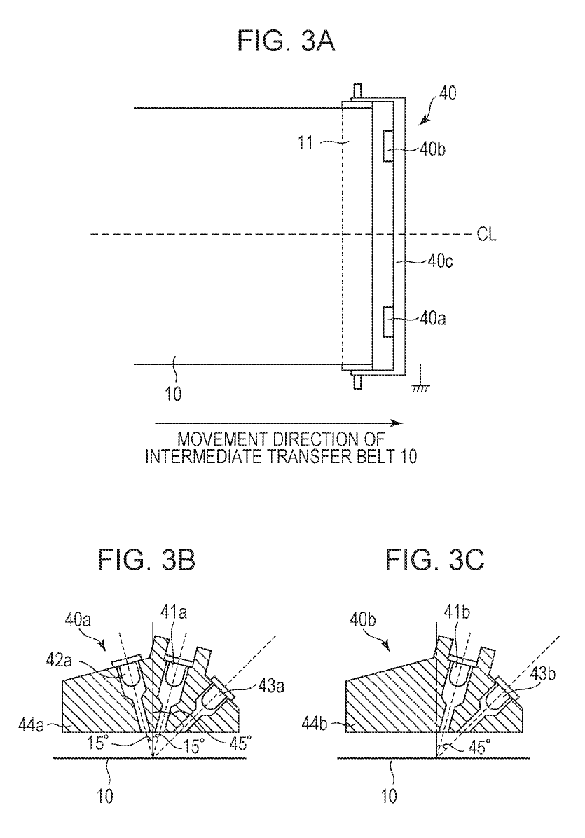

FIG. 3A is a schematic view for explaining a configuration of the detection unit 40. FIG. 3B is a schematic view for explaining a configuration of the first sensor 40a (first detection member) provided in the detection unit 40 and FIG. 3C is a schematic view for explaining a configuration of the second sensor 40b (second detection member) provided in the detection unit 40.

As illustrated in FIG. 3A, the detection unit 40 has two sensors of the first sensor 40a and the second sensor 40b, and the first sensor 40a and the second sensor 40b are held by a stay 40c as a holding member. The first sensor 40a and the second sensor 40b are arranged so as to be opposite to each other across a line segment CL that is a center line of the intermediate transfer belt 10 in a width direction orthogonal to a movement direction of the intermediate transfer belt 10. In the present exemplary embodiment, a distance from the line segment CL to each of the first sensor 40a and the second sensor 40b is 90 mm.

As illustrated in FIG. 3B, the first sensor 40a has a light emitting element 41a such as an LED, light receiving elements 42a and 43a such as a phototransistor, and a holder 44a. The light emitting element 41a is arranged so as to have an inclination of 15° with respect to the intermediate transfer belt 10 and radiates infrared light (for example, with a wavelength of 800 nm) to the test patch on the intermediate transfer belt 10 and the surface of the intermediate transfer belt 10. A region where the infrared light is radiated is a detection region, and a shape of the holder 44a is adjusted so that a spot diameter when the infrared light is radiated from the light emitting element 41a to the intermediate transfer belt 10 is 2 mm.

The light receiving element 43a is arranged so as to have an inclination of 45° with respect to the intermediate transfer belt 10 and receives the infrared light diffused and reflected by the test patch and the surface of the intermediate transfer belt 10. The light receiving element 42a is arranged so as to have an inclination of 15° with respect to the intermediate transfer belt 10 and receives specularly-reflected light and diffused reflected light of the infrared light, which are obtained from the test patch and the surface of the intermediate transfer belt 10. With the first sensor 40a, the test patch of the positional deviation control pattern, the density control pattern, or the like is able to be detected.

As illustrated in FIG. 3C, the second sensor 40b has a light emitting element 41b such as an LED, a light receiving element 43b such as a phototransistor, and a holder 44b. The light emitting element 41b is arranged so as to have an inclination of 15° with respect to the intermediate transfer belt 10 and has the same characteristic of an element as that of the light emitting element 41a. The light receiving element 43b is arranged so as to have an inclination of 45° with respect to the intermediate transfer belt 10 and has the same characteristic of an element as that of the light receiving element 43a. With the second sensor 40b, the test patch of the positional deviation control pattern is able to be detected.

### [Explanation of Correction Control of Image Formation Condition]

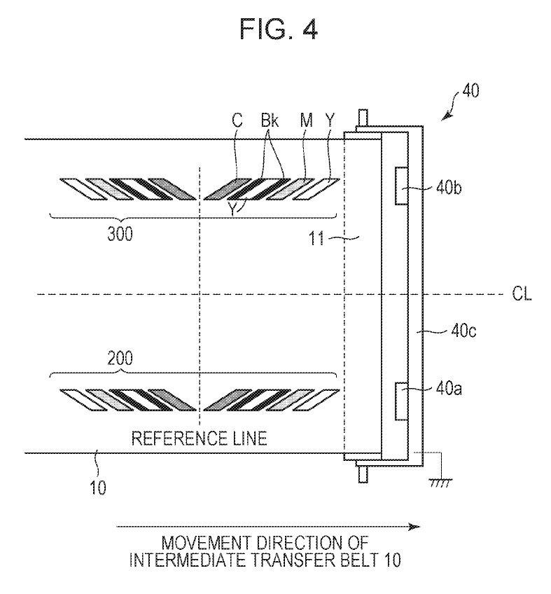

FIG. 4 is a schematic view for explaining a positional relationship between a test patch, which is formed on the intermediate transfer belt 10 when correction control (hereinafter, referred to as registration correction) to correct a position of an image is executed, and the first sensor 40a or the second sensor 40b in the present exemplary embodiment. As illustrated in FIG. 4, when the registration correction is performed, test patches 200 and 300 of the positional deviation control pattern are respectively formed at positions corresponding to the first sensor 40a and the second sensor 40b. Each of the test patch 200 and the test patch 300 is formed so that parallelogram patches of yellow (Y), magenta (M), cyan (C), and black (Bk) and parallelogram patches of yellow (Y), magenta (M), cyan (C), and black (Bk) are symmetrical with each other across a reference line.

The test patch 200 and the test patch 300 move as the intermediate transfer belt 10 moves, and diffuse and reflect the infrared light radiated from the light emitting element 41a, while passing through a position where the detection unit 40 faces the intermediate transfer belt 10. The registration correction is performed on the basis of a result obtained when the first sensor 40a and the second sensor 40b detect the diffused reflected light of the infrared light radiated to the test patch 200 and the test patch 300.

Among the infrared light radiated from the light emitting element 41a and the light emitting element 41b which are provided in the respective sensors, the reflected light from the intermediate transfer belt 10 is mainly specularly-reflected light and the reflected light from the toner of yellow (Y), magenta (M), and cyan (C) is diffused reflected light. That is, by detecting a timing at which a detection waveform of the diffused reflected light when the infrared light is radiated from the light emitting element 41a and the light emitting element 41b exceeds a preset threshold, it is possible to detect an edge of the toner of each of the colors of the test patch 200 and the test patch 300 and specify a position thereof. Since the infrared light is mainly absorbed by the toner of black, a position of the black toner is able to be specified by overlapping the toner of black and the toner of another color as illustrated in FIG. 4.

A light receiving intensity of the diffused reflected light received by the light receiving element 43a and the light receiving element 43b is converted into a voltage in the controller 274. Here, as a dynamic range which is a difference between a detection output of the intermediate transfer belt 10 and a detection output of the test patch 200 or the test patch 300 is wider, the edge of the toner is able to be detected stably regardless of external noise or the like.

The controller 274 detects a passing timing of the test patch 200 and the test patch 300 on the basis of the output from the detection unit 40 and calculates the position. By comparing the timing to a predetermined timing, the controller 274 calculates a relative amount of a color deviation in a main scanning direction and a sub-scanning direction among the toner of the respective colors, a magnification in the main scanning direction, a relative inclination, or the like. In accordance with a result thereof, relative positions of the toner of the respective colors are corrected, so that the registration correction is performed.

### [Explanation of Intermediate Transfer Belt]

In a case where the intermediate transfer belt has a high transmission property so that radiation light from the detection unit 40 is transmitted through the intermediate transfer belt and reflected light is generated from a counter object, the dynamic range described above may be reduced. Thus, it is necessary to reduce the transmission property of the intermediate transfer belt to perform detection stably.

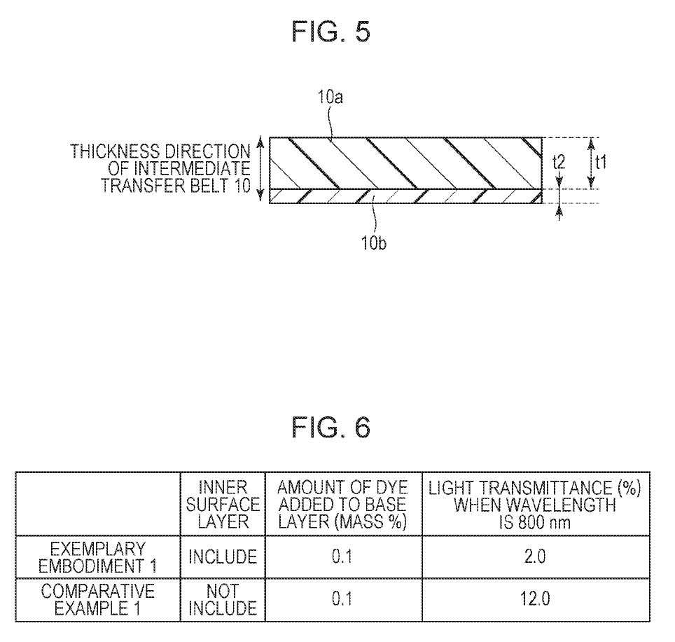

FIG. 5 illustrates a sectional surface of the intermediate transfer belt 10 in the present exemplary embodiment. As illustrated in FIG. 5, the intermediate transfer belt 10 has a base layer 10a (first layer) and an inner surface layer 10b (second layer) which serves as an infrared light absorption layer. Here, the base layer 10a is defined as a layer that is the thickest among layers forming the intermediate transfer belt 10 in a thickness direction of the intermediate transfer belt 10. In the present exemplary embodiment, the inner surface layer 10b is formed by applying spray coating on an inner circumferential surface of a substrate of the base layer 10a and blow molding is performed, so that the intermediate transfer belt 10 having a plurality of layers is obtained. After the blow molding, a thickness t1 of the base layer 10a is 64 μm and a thickness t2 of the inner surface layer 10b is 1 μm. The thickness t1 of the base layer 10a is desired to be in a range of 55 to 85 μm by considering a handling property in assembling and traces of stretching by the support roller 11, the stretching roller 12, and the facing roller 13.

In the present exemplary embodiment, a blow molding temperature, a speed, and the like of the intermediate transfer belt 10 are optimized so that a difference of the circumferential length at both ends of the intermediate transfer belt 10 in the width direction (main scanning direction) orthogonal to the movement direction is 0.5 mm or less and film thickness unevenness is 15 μm or less. Further, the blow molding temperature, the speed, and the like of the intermediate transfer belt 10 are optimized so that an elastic coefficient of the intermediate transfer belt 10 is about 2000 Mpa. Examples of a molding method of the intermediate transfer belt 10 include, in addition to the blow molding, centrifugal molding, tube extrusion, inflation molding, extrusion molding, and cylinder extrusion molding.

The base layer 10a is made of endless polyethylene naphthalate (PEN) mixed with an ion conductive agent as a conductive agent and has 0.1 mass % of dye added to perform blow molding. An amount of the ion conductive agent added to the base layer 10a is adjusted so that a volume resistivity of the intermediate transfer belt 10 is 5×10⁹ Ω·cm. The volume resistivity of the base layer 10a may be in a range of 1×10⁸ to 1×10¹² Ω·cm and is more desirably in a range of 1×10⁸ to 1×10¹¹ Ω·cm. Further, a surface gloss of the base layer 10a is adjusted to be 30 or more (the gloss is measured by Handy Gloss Meter IG-320 manufactured by Horiba, Ltd.) so that the infrared light radiated from the detection unit 40 is specularly-reflected by the surface of the intermediate transfer belt 10.

The inner surface layer 10b is made of polyurethane mixed with 50 mass % of phthalocyanine-based dye colorant as a coloring agent. A resistance value of the inner surface layer 10b is adjusted in a range of 1×10⁴ to 1×10¹⁰ Ω·cm by adding an ion conductive agent.

Here, a surface resistivity measured from the outer circumferential surface side of the intermediate transfer belt 10 is defined as a surface resistivity of the base layer 10a, and a surface resistivity measured from the inner circumferential surface side (inner surface layer 10b side) of the intermediate transfer belt 10 is defined as a surface resistivity of the inner surface layer 10b. In the configuration of the present exemplary embodiment, the surface resistivity of the base layer 10a may be in a range of 5.0×10⁸Ω/□ to 1.0×10¹²Ω/□ and is more desirably in a range of 1.0×10^{9.5}Ω/□ to 1.0×10¹¹Ω/□. The surface resistivity of the inner surface layer 10b may be in a range of 1.0×10⁷Ω/□ or less and is more desirably in a range of 1.0×10⁶Ω/□ or less.

The volume resistivity and the surface resistivity of the intermediate transfer belt 10 are measured by using Hiresta-UP (MCP-HT450) manufactured by Mitsubishi Chemical Corporation in a measurement environment of a temperature of 23° C. and a humidity of 50%. The volume resistivity is measured by using a ring probe of type UR (Model: MCP-HTP12) under a condition that the probe is brought into contact with the outer circumferential surface of the intermediate transfer belt 10 at an applied voltage of 100 V and a measurement time of 10 seconds. The surface resistivity is measured by using a ring probe of type UR100 (Model: MCP-HTP16) under a condition of an applied voltage of 100 V and a measurement time of 10 seconds for the outer circumferential surface side and an applied voltage of 10 V and a measurement time of 10 seconds for the inner circumferential surface side. The surface resistivity of the inner circumferential surface side of the intermediate transfer belt 10, that is, the surface resistivity of the inner surface layer 10b is measured by making the probe contact with the inner surface layer 10b side. The surface resistivity of the outer circumferential surface side of the intermediate transfer belt 10, that is, the surface resistivity of the base layer 10a is measured by making the probe contact with the base layer 10a side.

### Action and Effect of Present Exemplary Embodiment

FIG. 6 illustrates a result of measurement of a light transmittance of an intermediate transfer belt when a wavelength is 800 nm in the present exemplary embodiment and a comparative example 1. The measurement is performed by using an ultraviolet-visible-infrared spectrophotometer (UH4150 manufactured by Hitachi High-Tech Science Corporation) and arranging the intermediate transfer belt 10 between a light emitting unit and a detection unit of the spectrophotometer. More specifically, the measurement is performed with a distance of 290 mm between the light emitting unit and the intermediate transfer belt 10 and a distance of 190 mm between the intermediate transfer belt 10 and the detection unit. Note that, an intermediate transfer belt of the comparative example 1 has a configuration in which the inner surface layer 10b in the intermediate transfer belt 10 of the present exemplary embodiment is not included but only a layer corresponding to the base layer 10a is included.

As illustrated in FIG. 6, the light transmittance for the light with the wavelength of 800 nm in the present exemplary embodiment is 2.0% and a result indicating that the infrared light is hardly transmitted is obtained. On the other hand, because of not including the inner surface layer 10b, the intermediate transfer belt of the comparative example 1 exhibits a light transmission property higher than that of the intermediate transfer belt 10 of the present exemplary embodiment and has the light transmittance of 12% for the light with the wavelength of 800 nm.

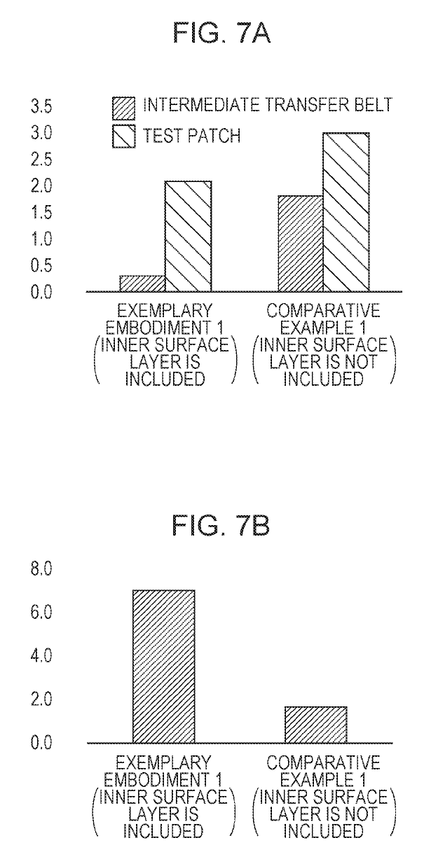

FIG. 7A illustrates a result obtained by, when each of the intermediate transfer belts of the present exemplary embodiment and the comparative example 1 is used, detecting by the light receiving element 43a diffused reflected light from the surface of the intermediate transfer belt and diffused reflected light from a test patch formed on the intermediate transfer belt. FIG. 7B illustrates a ratio obtained by dividing a detection output of the test patch by a detection output of the surface of the intermediate transfer belt in the present exemplary embodiment and the comparative example 1 on the basis of the detection result of FIG. 7A and illustrates an index of the dynamic range. It is indicated that as a value of a vertical axis increases, the dynamic range is wide and the test patch is able to be detected stably.

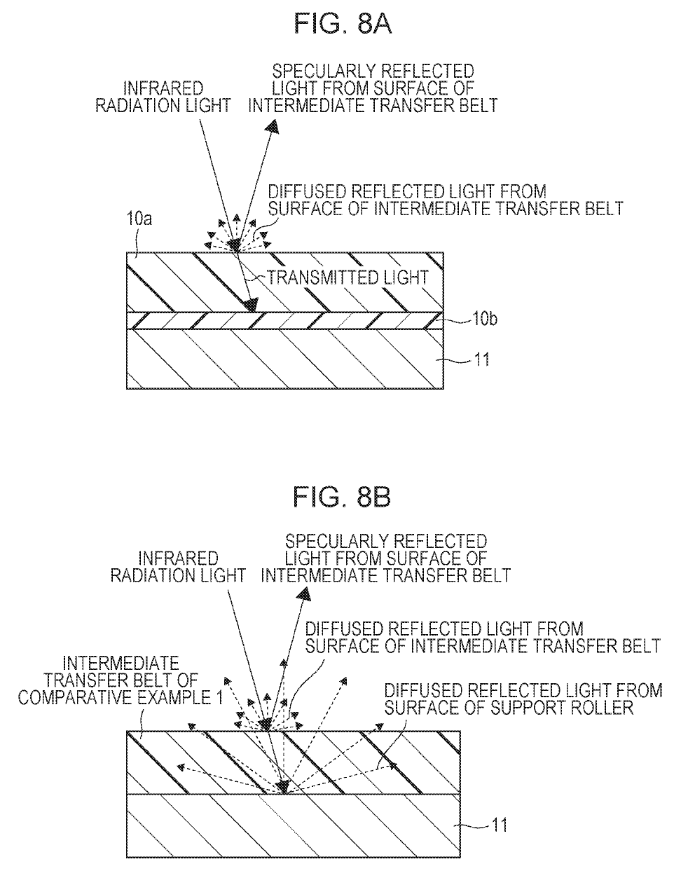

As illustrated in FIG. 7A, in the configuration of the present exemplary embodiment, the detection result of the diffused reflected light from the surface of the intermediate transfer belt 10, which is obtained by the light receiving element 43a, is 0.3 V. On the other hand, in the configuration of the comparative example 1, the detection result of the diffused reflected light from the surface of the intermediate transfer belt is 1.8 V and indicates a value higher than that of the present exemplary embodiment. A reason therefor will be described with reference to FIGS. 8A and 8B. FIG. 8A is a schematic view for explaining reflection of the infrared light when the infrared light is radiated to the intermediate transfer belt 10 in the configuration of the present exemplary embodiment. FIG. 8B is a schematic view for explaining reflection of the infrared light when the infrared light is radiated to the intermediate transfer belt in the configuration of the comparative example 1.

As illustrated in FIG. 8A, when the infrared light is radiated to the intermediate transfer belt 10, the infrared light is slightly diffused and reflected by the surface of the base layer 10a and a part of the infrared light transmitted through the base layer 10a is absorbed by the inner surface layer 10b. On the other hand, in the configuration of the comparative example 1 in which the inner surface layer 10b is not included, as illustrated in FIG. 8B, when the infrared light is radiated to the intermediate transfer belt, not only the diffused reflected light from the surface of the intermediate transfer belt but also a part of the infrared light transmitted through the intermediate transfer belt is diffused and reflected by a surface of the support roller 11. In particular, the support roller 11 that is made of stainless steel as a metal member easily reflects the infrared light due to a surface property thereof. As a result, as illustrated in FIG. 7A, the detection result of the diffused reflected light from the surface of the intermediate transfer belt in the configuration of the comparative example 1 indicates a value higher than that of the present exemplary embodiment.

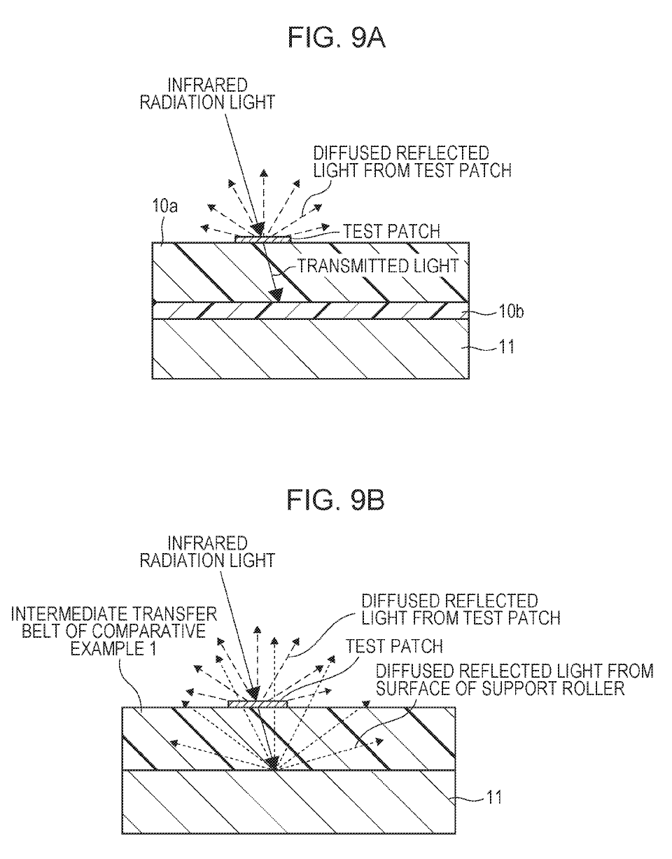

Moreover, as illustrated in FIG. 7A, in the configuration of the present exemplary embodiment, the detection result of the diffused reflected light from the test patch, which is obtained by the light receiving element 43a, is 2.1 V. On the other hand, in the configuration of the comparative example 1, the detection result of the diffused reflected light from the test patch is 3.0 V and indicates a value higher than that of the preset exemplary embodiment. A reason therefor will be described with reference to FIGS. 9A and 9B. FIG. 9A is a schematic view for explaining reflection of the infrared light when the infrared light is radiated to the test patch formed on the intermediate transfer belt 10 in the configuration of the present exemplary embodiment. FIG. 9B is a schematic view for explaining reflection of the infrared light when the infrared light is radiated to the test patch formed on the intermediate transfer belt in the configuration of the comparative example 1.

As illustrated in FIG. 9A, when the infrared light is radiated to the test patch formed on the intermediate transfer belt 10, the infrared light is diffused and reflected by the surface of the test patch and a part of the infrared light transmitted through the test patch and the base layer 10a is absorbed by the inner surface layer 10b. On the other hand, in the configuration of the comparative example 1 in which the inner surface layer 10b is not included, as illustrated in FIG. 9B, not only the infrared light diffused and reflected by the surface of the test patch but also a part of the infrared light transmitted through the test patch and the intermediate transfer belt is diffused and reflected by the surface of the support roller 11. As a result, as illustrated in FIG. 7A, the detection result of the diffused reflected light from the surface of the test patch in the configuration of the comparative example 1 indicates a value higher than that of the present exemplary embodiment.

As illustrated in FIG. 7B, in the configuration of the present exemplary embodiment, a value of the dynamic range obtained from the detection result of FIG. 7A is 7.0. According to the result, the registration correction is able to be performed stably in the configuration of the present exemplary embodiment regardless of disturbance such as deterioration of the intermediate transfer belt 10 over time or contamination of each of the sensors of the detection unit 40. On the other hand, in the configuration of the comparative example 1, the value of the dynamic range is 1.7 and indicates a value lower than that of the present exemplary embodiment. That is, when the intermediate transfer belt of the comparative example 1 is used, there is a possibility that a sufficient dynamic range is not able to be secured and the registration correction is not able to be performed stably depending on disturbance such as deterioration of the intermediate transfer belt over time or contamination of the sensor.

As described above, in the present exemplary embodiment, the inner surface layer 10b as the infrared light absorption layer is provided on the inner circumferential surface side of the base layer 10a, so that the transmission property of the intermediate transfer belt 10 is able to be reduced without deteriorating uniformity of the electrical resistance value of the intermediate transfer belt 10. Thereby, when correction control to correct the image formation condition such as a position or density of an image is executed, occurrence of erroneous detection caused when the light radiated from the detection unit 40 to the intermediate transfer belt 10 and the test patch is transmitted through the intermediate transfer belt 10 is able to be suppressed.

When the light transmittance is suppressed to 7.5% or less by the inner surface layer 10b, the dynamic range is 3.0 or more and stable registration detection is able to be expected. It is more desirable that the light transmittance is 6.0% or less so that the dynamic range is secured to be 4.0 or more.

The example in which the registration correction is performed by using the detection result of the diffused reflected light has been described in the present exemplary embodiment, but there is no limitation thereto and the registration correction is also able to be performed by using a detection result of specularly-reflected light. Also in such a case, by providing the inner surface layer 10b, it is possible to stabilize accuracy of the detection in the correction control.

In a case where the registration correction is performed by using a detection result of specularly-reflected light, the correction control is performed by utilizing that the light receiving element 42a that detects the specularly-reflected light exhibits strong light receiving intensity with respect to the intermediate transfer belt 10 but weak light receiving intensity with respect to the test patch. More specifically, since the light receiving element 42a receives only reflected light in a specular reflection direction among the diffused reflected light from the test patch, the light receiving intensity becomes weak in a border between the intermediate transfer belt 10 and the test patch. Thus, by detecting a timing when a detection output exceeds a predetermined threshold before and after passing of the test patch, a position of the test patch is able to be specified.

The detection of the specularly-reflected light has a characteristic that a reflection direction changes due to surface unevenness of a reflective object and the light receiving intensity greatly changes. Thus, in a case where a foreign substance from outside, scraping powder of the intermediate transfer belt 10, or the like is accumulated on the support roller 11, when the infrared light is transmitted through the intermediate transfer belt 10 and radiated to the foreign substance, a reflection component in the specular reflection direction is reduced, so that the foreign substance may be erroneously detected as the test patch. According to the configuration of the present exemplary embodiment, by forming the inner surface layer 10b, the light transmitted through the intermediate transfer belt 10 among the infrared light radiated from the detection unit 40 is absorbed by the inner surface layer 10b, thus making it possible to prevent such erroneous detection.

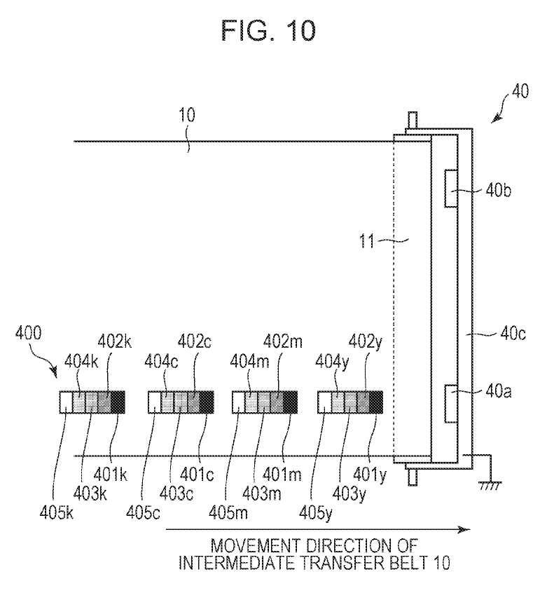

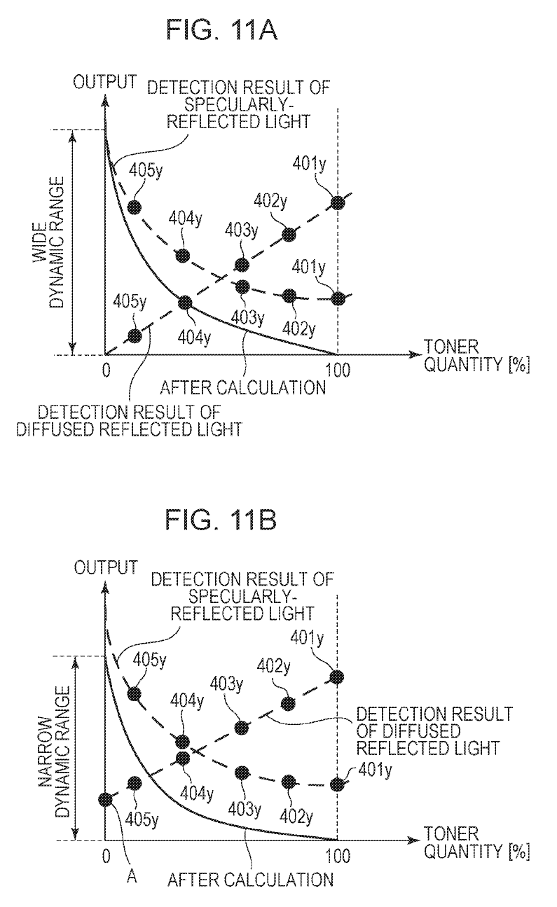

Though the registration correction has been described in the present exemplary embodiment, the disclosure is not limited thereto and is effective also when density correction to correct a density of an image is performed as correction control of the image formation condition by the detection unit 40. The density correction will be briefly described below with reference to FIGS. 10, 11A, and 11B. FIG. 10 is a schematic view of a test patch 400 formed on the intermediate transfer belt 10 when density correction is executed. FIG. 11A is a graph of a detection result of the test patch 400 in the configuration of the present exemplary embodiment and FIG. 11B is a graph indicating a detection result of the test patch 400 in the configuration of the comparative example 1 in which the inner surface layer 10b is not provided in the intermediate transfer belt.

As illustrated in FIG. 10, when the density correction is performed, patterns of yellow (Y), magenta (M), cyan (C), and black (Bk) each having five gradations are formed at positions corresponding to the first sensor 40a of the intermediate transfer belt 10. The detection result of the test patch 400 by the first sensor 40a is processed by the controller 274. Specifically, a signal of a light receiving quantity of the first sensor 40a is subjected to A/D (analog-to-digital) conversion and then output to the controller 274, and a net quantity of the specularly-reflected light is calculated by the CPU 276 in the controller 274. Then, on the basis of a result thereof, the controller 274 sets a density factor such as a charging voltage, a development voltage, or a quantity of exposure light. A result of the setting of the density factor is stored in the memory 275 in the controller 274 and used, for example, when image formation is performed or next density correction is executed.

Here, as an example, a detection result of the yellow gradation pattern of the test patch 400 in the configuration of the present exemplary embodiment is indicated in FIG. 11A. In the density correction, a detection output is standardized so that a detection output of the specularly-reflected light and a detection output of the diffused reflected light in a patch 401Y at which a toner quantity (density) is 100% are equal, and a difference between an output of the specularly-reflected light and an output of the diffused reflected light is obtained to thereby calculate a net quantity of the specularly-reflected light. By performing such calculation, the graph after the calculation as illustrated in FIG. 11A is obtained, and the density correction is performed on the basis of a result in which the net quantity of the specularly-reflected light and the toner quantity are associated. In the present exemplary embodiment, though description has been given by taking yellow as an example, the calculation is able to be performed in a similar manner also for magenta, cyan, and black.

As illustrated in FIG. 11B, in the configuration of the comparative example 1 using the intermediate transfer belt that does not include the inner surface layer 10b, the net quantity of the specularly-reflected light after the calculation when the toner quantity is zero is smaller than that of the present exemplary embodiment. In the configuration of the comparative example 1, the infrared light radiated from the light emitting element 41b is transmitted through the intermediate transfer belt and diffused and reflected by the surface of the support roller 11. When the diffused reflected light is detected by the light receiving element 43b, a result indicating that the detection output of the light receiving element 43b is not zero even when the toner quantity is zero as indicated by a dot A of FIG. 11A is obtained. As a result, as illustrated in FIGS. 11A and 11B, the dynamic range in the configuration of the comparative example 1 is narrower than the dynamic range in the configuration of the present exemplary embodiment using the intermediate transfer belt 10 that includes the inner surface layer 10b. Thus, it is desirable also in the density correction that the inner surface layer 10b is formed and the light transmitted through the base layer 10a is absorbed by the inner surface layer 10b as in the present exemplary embodiment.

Though the PEN is used as the resin material of the substrate of the intermediate transfer belt 10 in the present exemplary embodiment, thermoplastic resin, thermosetting resin, or the like is usable. Further, an additive such as conductive polymer as a conductive agent, an electrolyte, a compatibilizer, a dispersing agent, and various fillers may be applied additionally in accordance with a property that is required.

Note that, though 0.1 mass % of dye is added as the coloring agent added to the base layer 10a in the present exemplary embodiment, transmission of the infrared light is able to be suppressed by further adding the coloring agent. The base layer 10a is thicker than the inner surface layer 10b and is thus able to suppress transmission of the infrared light even when the addition amount is small. In order to achieve a range not to cause a problem in variation of the electric resistance or a molding property of the intermediate transfer belt 10, however, the addition of the coloring agent to the base layer 10a is desired to be adjusted in a range of 0.5 mass % or less.

Though 50 mass % of phthalocyanine-based dye colorant is added to the inner surface layer 10b with the thickness of 1 μm in the present exemplary embodiment, the inner surface layer 10b may be made thicker to further suppress transmission of the infrared light. For example, when the thickness of the inner surface layer 10b is 2 μm, the amount of the phthalocyanine-based dye colorant added in the thickness of 2 μm is twice that of a case where the thickness is 1 μm, so that the transmission of the infrared light is reduced. When the thickness of the inner surface layer 10b is increased up to 4 μm, the transmittance is almost 0%.

Even when the film thickness of the inner surface layer 10b is 1 μm, the transmittance of the infrared light is able to be reduced by increasing the phthalocyanine-based dye colorant. For example, when 75 mass % of dye colorant is added, the transmittance is almost 0%. The addition amount of the phthalocyanine-based dye colorant may be appropriately adjusted in view of a material cost or a range in which a desired dynamic range is obtained. In the configuration of the image forming apparatus 100 of the present exemplary embodiment, when the addition amount of the phthalocyanine-based dye colorant is 40 mass % or more, the transmittance of the infrared light is 4% or less and a sufficient effect is obtained. Moreover, the thickness of the inner surface layer 10b may be 1 μm or more in view of the transmittance of the infrared light and may be 10 μm or less to secure appropriate flexibility in view of prevention of cracking of the intermediate transfer belt 10 due to an increase in hardness of the intermediate transfer belt 10.

Though the polyurethane is used as the material used for the inner surface layer 10b, thermoplastic resin, thermosetting resin, ultraviolet-curing resin, or the like is usable. An example of a method of molding the inner surface layer 10b includes two-color molding with the substrate, for example, by spin coating or roll coating in addition to spray coating. Further, though the inner surface layer 10b is formed on the inner circumferential surface side of the intermediate transfer belt 10 in the present exemplary embodiment, there is no limitation thereto and a similar effect to that of the present exemplary embodiment is also able to be obtained when the infrared light absorption layer of the present exemplary embodiment is provided on the outer circumferential surface side of the intermediate transfer belt 10. When the infrared light absorption layer is provided on the outer circumferential surface side of the intermediate transfer belt 10, the infrared light absorption layer may be formed by spray coating similarly to the inner surface layer 10b of the present exemplary embodiment or may be formed by another method described above.

The configuration in which the first sensor 40a capable of detecting specularly-reflected light and diffused reflected light and the second sensor 40b capable of detecting diffused reflected light are provided as the detection unit 40 has been described in the present exemplary embodiment. However, there is no limitation thereto and both of the two sensors may be sensors capable of detecting specularly-reflected light and diffused reflected light. A configuration may be such that only a light receiving element detecting specularly-reflected light is provided as the second sensor 40b but a light receiving element detecting diffused reflected light is not provided or that one sensor detects specularly-reflected light and the other sensor detects diffused reflected light. According to the configuration in which one of the two sensors is able to detect specularly-reflected light and diffused reflected light as in the present exemplary embodiment, since a light receiving element detecting specularly-reflected light is not provided in the second sensor 40b, it is possible to achieve simplification of the configuration of the second sensor 40b and cost reduction.

Moreover, in order to detect a positional deviation in the main scanning direction when the registration correction is performed, it is desirable that two sensors are provided as in the present exemplary embodiment, but there is no limitation thereto and only one first sensor 40a may be provided or the number of sensors may be increased to three or more.

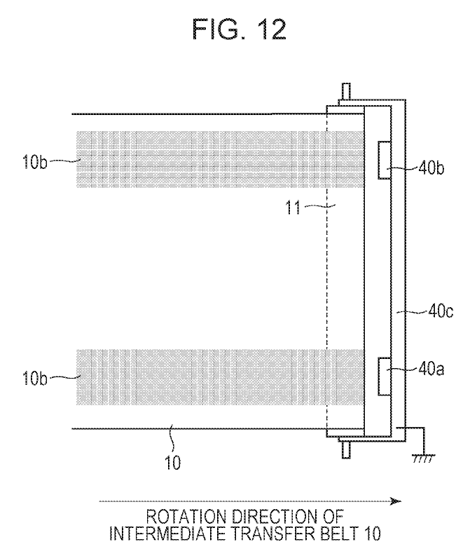

In the present exemplary embodiment, the inner surface layer 10b is formed on the entire inner circumferential surface side of the base layer 10a of the intermediate transfer belt 10. However, there is no limitation thereto and the inner surface layer 10b may be formed only at positions corresponding to the first sensor 40a and the second sensor 40b as illustrated in FIG. 12. The inner surface layer 10b may be formed at least in a region of one full circumference of the intermediate transfer belt 10, which faces the positions where the first sensor 40a and the second sensor 40b are arranged in the width direction of the intermediate transfer belt 10. The inner surface layer 10b is applied to a rear side of the base layer 10a by spray coating, spin coating, roll coating, or the like, and it takes longer time to form the layer as an application region is larger, and a material cost increases as the application region is larger. Thus, by applying the inner surface layer 10b to a required minimum region as illustrated in FIG. 12, it is possible to shorten a time of a formation step and suppress a material cost.

### Exemplary Embodiment 2

The configuration in which the phthalocyanine-based dye colorant is used as the coloring agent of the inner surface layer 10b has been described in the exemplary embodiment 1. On the other hand, a configuration in which carbon black is used as a coloring agent of an inner surface layer 110b will be described in an exemplary embodiment 2. Note that, the configuration of the present exemplary embodiment is almost the same as that of the exemplary embodiment 1 except for that the carbon black is used as the coloring agent of the inner surface layer 110b. Thus, hereinafter, a part common to that of the exemplary embodiment 1 will be given the same reference sign and description thereof will be omitted.

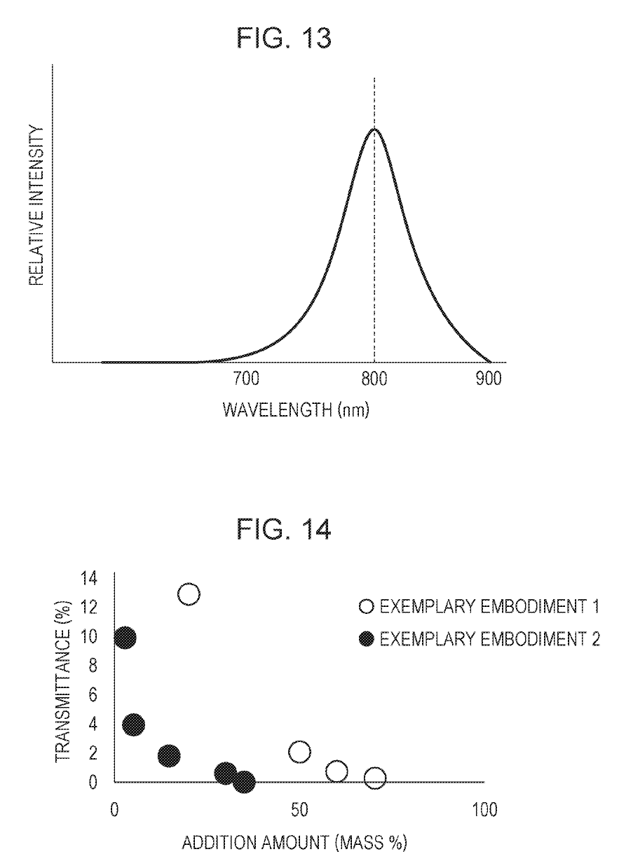

In a case of the dye colorant, when only a single compound is added, absorption efficiency is high in a specific wavelength region, but the absorption efficiency is reduced in the other wavelength region. Thus, for example, in a case of a light emitting element that has distribution in a wavelength region as illustrated in FIG. 13 or in a case where a peak wavelength varies due to individual variations of light emitting elements, radiation light of a part of the wavelength region may be transmitted through the inner surface layer 10b. In order to sufficiently obtain an effect of absorbing the infrared light by the inner surface layer 10b, a colorant that is able to widely absorb the infrared light near 800 nm which is the peak wavelength of the light emitting elements 41a and 41b needs to be added. In a case where the dye colorant is used as the coloring agent, however, a plurality of compounds need to be mixed and added, so that an addition amount may be increased.

Thus, in the present exemplary embodiment, the carbon black is added to the inner surface layer 110b as the coloring agent that is able to widely absorb the light of an infrared wavelength region even when an addition amount is small. FIG. 14 is a graph for explaining a relationship between the addition amount of the coloring agent and the transmittance of the infrared light in each of intermediate transfer belts of the exemplary embodiment 1 and the exemplary embodiment 2. As illustrated in FIG. 14, when comparison is performed with the same addition amount, the transmittance of the infrared light in an intermediate transfer belt 110 in which the carbon black is added to the inner surface layer 110b is lower than the transmittance of the infrared light in the intermediate transfer belt 10 in which the phthalocyanine-based dye colorant is added to the inner surface layer 10b.

That is, in a case where the carbon black is used as the coloring agent, with the addition amount less than that of the phthalocyanine-based dye colorant, an equivalent absorption efficiency of the infrared light is obtained. In this manner, in the present exemplary embodiment, by adding the carbon black to the inner surface layer 110b as the coloring agent, it is possible to obtain a similar effect to that of the exemplary embodiment 1 and also possible to achieve the inner surface 110b in which the absorption efficiency of the infrared light is further improved.

Note that, in the configuration of the present exemplary embodiment, when the amount of the carbon black added to the inner surface layer 110b is 5 mass % or more, the transmittance of the infrared light is 4% or less and a sufficient effect is obtained. On the other hand, in a case where the amount of the carbon black added to the inner surface layer 110b increases, when the intermediate transfer belt 110 is rotated and moved, the intermediate transfer belt 110 contacts support rollers 11, 12, and 13, so that the inner surface layer 110b may be scraped off. Thus, the amount of the carbon black added to the inner surface layer 110b is desirably 5 mass % to 50 mass % or less, and is more desirably in a range of 5 mass % to 20 mass %.

In the present exemplary embodiment, the intermediate transfer belt 110 in which a base layer 110a and the inner surface layer 110b are different in electric resistance by adding the carbon black is used, and the electric resistance of the inner surface layer 110b is set to be lower than that of the base layer 110a. Here, a surface resistivity measured from the outer circumferential surface side (base layer 110a side) of the intermediate transfer belt 110 is defined as the electric resistance of the base layer 110a, and a surface resistivity measured from the inner circumferential surface side (inner surface layer 110b side) thereof is defined as the electric resistance of the inner surface layer 110b. That is, in the intermediate transfer belt 110 of the present exemplary embodiment, the surface resistivity measured from the outer circumferential surface side and the surface resistivity measured from the inner circumferential surface side have different values and an electric resistance value of the surface resistivity measured from the inner circumferential surface side is smaller than that of the surface resistivity measured from the outer circumferential surface side.

Further, in the intermediate transfer belt 110 of the present exemplary embodiment, because of a relationship between the base layer 110a and the inner surface layer 110b with respect to the electric resistances and the thicknesses thereof, the volume resistivity of the intermediate transfer belt 110 reflects the electric resistance of the base layer 110a. In a reference environment (with a temperature of 23° C. and a humidity of 50%), the surface resistivity measured from the outer circumferential surface side of the intermediate transfer belt 110 is 3.2×10⁹Ω/□ and the surface resistivity measured from the inner circumferential surface side of the intermediate transfer belt 110 is 1.0×10⁶Ω/□. Moreover, the volume resistivity is 5×10⁹ Ω·cm.

Here, it is desirable that the resistivity of the intermediate transfer belt 110 in the configuration of the present exemplary embodiment is set to be in the following range. The electric resistance of the base layer 110a, that is, the surface resistivity measured from the outer circumferential surface side of the intermediate transfer belt 110 is desirably set to be in a range of 5.0×10⁸Ω/□ to 1.0×10¹²Ω/□, and more desirably set to be in a range of 1.0×10^{9.5}Ω/□ to 1.0×10¹¹Ω/□. A range of the surface resistivity of the inner circumferential surface side is desirably 1.0×10⁷Ω/□ or less and more desirably 1.0×10⁶Ω/□ or less. A range of the volume resistivity thereof is desirably 5.0×10⁸Ω·cm to 8.0×10¹¹ Ω·cm.

The volume resistivity and the surface resistivity of the intermediate transfer belt 110 are measured by using Hiresta-UP (MCP-HT450) manufactured by Mitsubishi Chemical Corporation in a measurement environment of a temperature of 23° C. and a humidity of 50%. The volume resistivity is measured by using a ring probe of type UR (Model: MCP-HTP12) under a condition that the probe is brought into contact with the outer circumferential surface of the intermediate transfer belt 110 at an applied voltage of 100 V and a measurement time of 10 seconds. The surface resistivity is measured by using a ring probe of type UR100 (Model: MCP-HTP16) under a condition of an applied voltage of 100 V and a measurement time of 10 seconds for the outer circumferential surface side and an applied voltage of 10 V and a measurement time of 10 seconds for the inner circumferential surface side. The surface resistivity of the inner circumferential surface side of the intermediate transfer belt 110 is measured by making the probe contact with the inner surface layer 110b side and the surface resistivity of the outer circumferential surface side of the intermediate transfer belt 110 is measured by making the probe contact with the base layer 110a side.

### Exemplary Embodiment 3

Though the carbon black is added as the coloring agent in the exemplary embodiment 2, the carbon black is an aggregate of particles having a diameter of 3 nm to 500 nm and the transmittance of the infrared light changes depending on the particle diameter or a structure of the aggregate. As the particle diameter decreases, the transmittance of the infrared light tends to be reduced, but dispersibility of the carbon black tends to be lowered and the transmittance may have a variation. When the structure of the aggregate is enlarged, the dispersibility tends to be enhanced to reduce the variation of the transmittance, whereas the transmittance of the infrared light tends to be increased. In a case where the carbon black is used as the coloring agent, by increasing the addition amount of the carbon black, it is possible to achieve both reduction in the transmittance of the infrared light and suppression of the variation of the transmittance.

Thus, an exemplary embodiment 3 is characterized in that carbon nanotube is added to an inner surface layer 210b as a coloring agent capable of reducing the transmittance of the infrared light even when an addition amount is smaller. Note that, the configuration of the present exemplary embodiment is almost the same as that of the exemplary embodiment 1 except for that the carbon nanotube is used as the coloring agent of the inner surface layer 210b. Thus, hereinafter, a part common to that of the exemplary embodiment 1 will be given the same reference sign and description thereof will be omitted.

In the present exemplary embodiment, carbon nanotube having a typical cylindrical structure in which carbon six-membered ring structures are connected is dispersed in polyurethane that is a substrate of the inner surface layer 210b of an intermediate transfer belt 210. By using the carbon nanotube having the cylindrical structure as the coloring agent, the infrared light transmitted through a base layer 210a of the intermediate transfer belt 210 is repeatedly subjected to reflection and attenuation in the cylindrical structure of the carbon nanotube dispersed in the inner surface layer 210b and disappears. Thereby, in the present exemplary embodiment, it is possible to obtain a similar effect to those of the exemplary embodiment 1 and the exemplary embodiment 2 and also possible to achieve the intermediate transfer belt 210 that has a lowered transmission property of the infrared light with a reduced addition amount of the coloring agent.

### Exemplary Embodiment 4

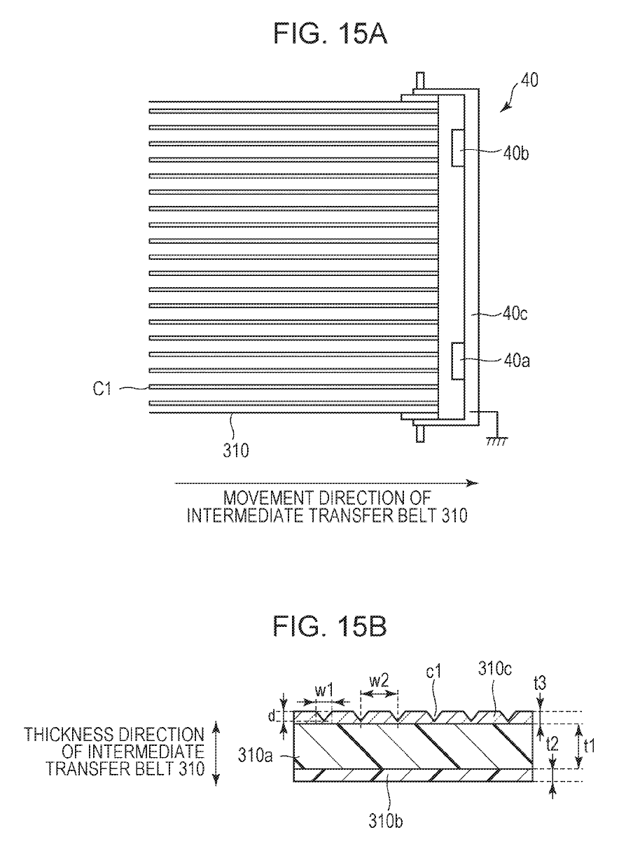

The intermediate transfer belt 110 that has the base layer 110a and the inner surface layer 110b has been described in the exemplary embodiment 2. On the other hand, as illustrated in FIGS. 15A and 15B, an intermediate transfer belt 310 of an exemplary embodiment 4 is different from that of the exemplary embodiment 1 in terms of including a base layer 310a, an inner surface layer 310b, and a surface layer 310c in which grooves are formed in a movement direction of the intermediate transfer belt 310. FIG. 15A is a schematic view of a configuration of the intermediate transfer belt 310 and FIG. 15B is a schematic sectional view of the intermediate transfer belt 310 as viewed from the movement direction of the intermediate transfer belt 310. Note that, the configuration of the present exemplary embodiment is almost the same as that of the exemplary embodiment 1 except for that the surface layer 310c is provided. Thus, hereinafter, a part common to that of the exemplary embodiment 1 will be given the same reference sign and description thereof will be omitted.

As illustrated in FIG. 1, the cleaning blade 16a is brought into pressure contact with the intermediate transfer belt 310 from a counter direction to the movement direction of the intermediate transfer belt 10. Thus, in a case where a friction coefficient of a part where the intermediate transfer belt 310 is brought into pressure contact with the cleaning blade 16a is large, it is concerned that the cleaning blade 16a is turned over or worn due to repetitive usage. When the wear is caused, slipping-through of toner is generated starting from the worn part so that cleaning failure may occur.

Thus, in the present exemplary embodiment, as illustrated in FIGS. 15A and 15B, in order to suppress the occurrence of the cleaning failure, the surface layer 310c (third layer) in which grooves c1 are formed along the movement direction of the intermediate transfer belt 310 is provided on a surface of the intermediate transfer belt 310. By providing the surface layer 310c having the grooves c1, an area where the cleaning blade 16a contacts the intermediate transfer belt 310 is reduced, so that the friction coefficient between the intermediate transfer belt 310 and the cleaning blade 16a is able to be reduced. As a result, it is possible to improve cleaning performance of the image forming apparatus 100.

### [Explanation of Intermediate Transfer Belt]

As illustrated in FIG. 15B, the intermediate transfer belt 310 of the present exemplary embodiment is configured by three layers in a thickness direction. Configurations and forming methods of the base layer 310a and the inner surface layer 310b are similar to those of the exemplary embodiment 1. Moreover, as a coloring agent added to the inner surface layer 310b, a phthalocyanine-based dye colorant, carbon black, carbon nanotube, or the like is usable. In the present exemplary embodiment, 10 mass % of carbon black is added and the surface resistivity of the inner surface layer 310b is 1.0×10⁶Ω/□. Note that, desirable ranges of the electric resistances of the base layer 310a and the inner surface layer 310b of the intermediate transfer belt 310 in the present exemplary embodiment are similar to the ranges of the exemplary embodiment 2, so that description thereof will be omitted.

The surface layer 310c is a transparent layer with a thickness of about 2 μm, which is obtained by adding a resistance adjusting agent and a surface lubricant to an outer circumferential surface side of the base layer 310a by using acrylic resin as a substrate and which has higher light transmittance than that of the base layer 310a. Note that, antinomy dope is used as the resistance adjusting agent and polytetrafluoroethylene (hereinafter, referred to as PTFE) is used as the surface lubricant. On the surface of the surface layer 310c, grooves c are periodically formed at a predetermined interval in a width direction of the intermediate transfer belt 310. As illustrated in FIG. 15B, the groves c1 are formed by a surface treatment so that a groove width w1 is 2 μm, a groove depth d is 1 μm, and a groove pitch w2 which is an interval between grooves is 20 μm.

As the groove pitch w2 is wider, the area where the cleaning blade 16a contacts the intermediate transfer belt 310 is increased. In such a case, toner remining on the intermediate transfer belt 310 is difficult to pass through the cleaning blade 16a, whereas the cleaning blade 16a is easily worn in a part where the cleaning blade 16a contacts the intermediate transfer belt 310. On the other hand, as the groove pitch w2 is narrower, the area where the cleaning blade 16a contacts the intermediate transfer belt 310 is reduced and wear of the cleaning blade 16a in the part where the cleaning blade 16a contacts the intermediate transfer belt 310 is suppressed. In such a case, however, cleaning failure is easily generated when the toner remining on the intermediate transfer belt 310 passes through the part where the cleaning blade 16a contacts the intermediate transfer belt 310. Due to the foregoing reasons, in consideration of slipping-through of the toner remaining on the intermediate transfer belt 310 and wearability of the cleaning blade 16a, the groove pitch w2 is desirably in a range of 3 μm to 50 μm in the configuration of the present exemplary embodiment.

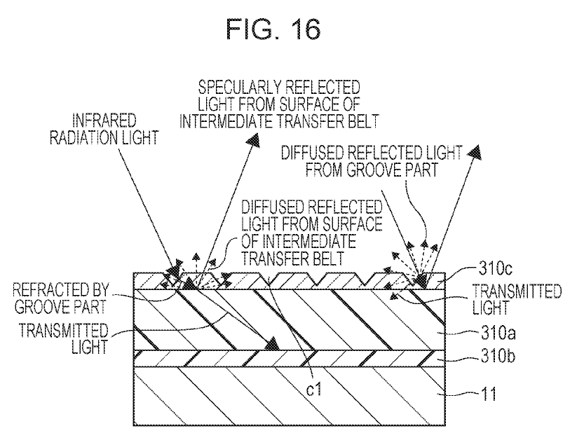

In a case where a groove shape is formed in the surface layer 310c as in the intermediate transfer belt 310, radiation light radiated from the detection unit 40 is also reflected by a side surface of a groove c1. FIG. 16 illustrates how the infrared light radiated from the detection unit 40 to the intermediate transfer belt of the present exemplary embodiment is reflected. In the present exemplary embodiment, diffused reflected light from the groove c1, specularly-reflected light that is refracted by the surface layer 310c, and the like are added in addition to the specularly-reflected light and the diffused reflected light which are described in the exemplary embodiment 1, so that reflected light received by the light receiving element 43a tends to be increased.

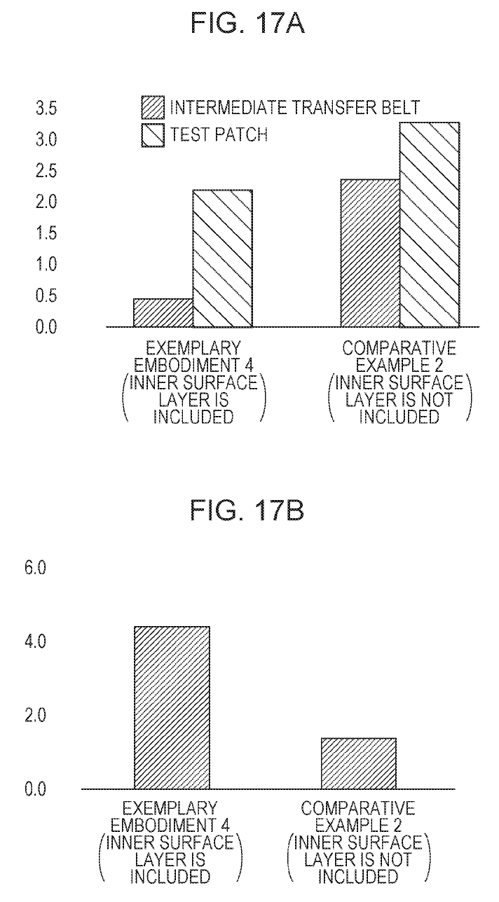

FIG. 17A illustrates a result obtained by, when each of intermediate transfer belts of the present exemplary embodiment and a comparative example 2 are used, detecting by the light receiving element 43a diffused reflected light from the surface of the intermediate transfer belt and diffused reflected light from a test patch formed on the intermediate transfer belt. FIG. 17B illustrates a ratio obtained by dividing a detection output of the test patch by a detection output of the surface of the intermediate transfer belt in the present exemplary embodiment and the comparative example 2 on the basis of the detection result of FIG. 17A and illustrates an index of the dynamic range. Note that, the intermediate transfer belt of the comparative example 2 has a configuration in which the inner surface layer 310b in the intermediate transfer belt 310 of the present exemplary embodiment is not included but only layers corresponding to the base layer 310a and the surface layer 310c are included.

As illustrated in FIG. 17A, in the configuration of the present exemplary embodiment, the detection result of the diffused reflected light from the surface of the intermediate transfer belt 310, which is obtained by the light receiving element 43a, is 0.5 V. The result is obtained by detecting diffused reflected light generated at the groove c1 of the surface layer 310c and specularly-reflected light refracted by the groove c1 part in addition to the diffused reflected light from the base layer 310a of the intermediate transfer belt 310. Similarly to the exemplary embodiment 1, a part of the infrared light radiated from the light emitting element 41a is transmitted through the base layer 310a and then absorbed by the inner surface layer 310b.

On the other hand, in the configuration of the comparative example 2, the detection result of the diffused reflected light from the surface of the intermediate transfer belt is 2.4 V and indicates a value higher than that of the present exemplary embodiment. This is because not only the diffused reflected light that is reflected by the surface of the intermediate transfer belt, the diffused reflected light that is generated at the groove part of the surface layer, and the specularly-reflected light that is refracted by the groove part but also a part of the infrared light transmitted through the intermediate transfer belt is diffused and reflected by the surface of the support roller 11 in the configuration of the comparative example 2.

As illustrated in FIG. 17A, in the configuration of the present exemplary embodiment, the detection result of the diffused reflected light from the test patch, which is obtained by the light receiving element 43a, is 2.1 V. On the other hand, in the configuration of the comparative example 2, the detection result of the diffused reflected light from the test patch is 3.3 V and indicates a value higher than that of the present exemplary embodiment. This is because, in the configuration of the comparative example 2 in which the inner surface layer 310b is not included, not only the diffused reflected light that is reflected by the test patch and the like but also a part of the infrared light transmitted through the test patch and the intermediate transfer belt is diffused and reflected by the surface of the support roller 11.

As illustrated in FIG. 17B, in the configuration of the present exemplary embodiment, a value of the dynamic range is 4.4. According to the result, similarly to the exemplary embodiment 1, the correction control of the image formation condition is able to be performed stably in the configuration of the present exemplary embodiment regardless of disturbance such as deterioration of the intermediate transfer belt 310 over time or contamination of each of the sensors of the detection unit 40. On the other hand, in the configuration of the comparative example 2, the value of the dynamic range is 1.7 and indicates a value lower than that of the present exemplary embodiment. That is, when the intermediate transfer belt of the comparative example 2 is used, there is a possibility that a sufficient dynamic range is not able to be secured and the correction control of the image formation condition is not able to be performed stably depending on disturbance such as deterioration of the intermediate transfer belt over time or contamination of the sensor.

As described above, according to the present embodiment, even when the dynamic range by the diffused reflected light from the surface layer 310c is reduced due to the grooves c1 formed in the surface layer 310c of the intermediate transfer belt 310, the correction control is able to be stably performed by providing the inner surface layer 310b. Thus, the configuration of the present exemplary embodiment is also able to obtain a similar effect to those of the exemplary embodiments 1 to 3. Moreover, by forming the grooves c in the surface layer 310c, it is possible to improve cleaning performance of the image forming apparatus 100.

Here, as a method of forming the groove shape in the surface layer 310c of the intermediate transfer belt 310, methods of polishing processing, cutting processing, imprint processing, and the like are usable. By appropriately selecting and using a desirable one from among the forming methods, the intermediate transfer belt 310 in which the grooves c are provided in the surface layer 310c in the present exemplary embodiment is able to be obtained. Among them, the imprint processing that utilizes a photosetting property of acrylic resin as the substrate of the surface layer 310c is suitably performed from a viewpoint of a processing cost and productivity. Without limitation to such imprint processing, the groove shape may be formed by curing the acrylic resin and then applying lapping processing.

The configuration in which the plurality of grooves c1 are periodically formed in the width direction of the intermediate transfer belt 310 has been described in the present exemplary embodiment, but there is no limitation thereto and the grooves c may not be necessarily provided periodically. As long as the grooves c are formed at least in a region on which the infrared light radiated from the light emitting elements 41a and 41b is fallen, the aforementioned dynamic range by the diffused reflected light from the surface layer 310c may be reduced. Then, by providing the intermediate transfer belt 310 in such a case, the effect described in the present exemplary embodiment is able to be sufficiently obtained.

Moreover, the grooves c1 may not be formed continuously over one full circumference of the intermediate transfer belt 310 along the movement direction of the intermediate transfer belt 310 and may be formed discontinuously at a halfway point. That is, the grooves c may be intermittently formed over one full circumference of the intermediate transfer belt 310. The grooves c may extend along a direction intersecting with the width direction orthogonal to the movement direction of the intermediate transfer belt 310 and may be formed in a state of having an angle with respect to the movement direction of the intermediate transfer belt 310. In order to obtain an effect of reducing a friction coefficient between the intermediate transfer belt 310 and the cleaning blade 16a, however, the angle formed by the direction in which the grooves c1 extend with respect to the movement direction of the intermediate transfer belt 310 is desirably 45° or less, and more desirably 10° or less.

Note that, though description has been given for the image forming apparatus 100 of an intermediate transfer system using the intermediate transfer belt has been described in the exemplary embodiments 1 to 4, there is no limitation thereto and the effect described above is also able to be achieved by an image forming apparatus of a direct transfer system that has a conveyance belt which conveys the transfer material P.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-068245, filed Mar. 30, 2018 and No. 2019-019539 filed Feb. 6, 2019, which are hereby incorporated by reference herein in their entirety.

What is claimed is:

1. An image forming apparatus comprising:
an image bearing member configured to bear a toner image;
a movable belt that is configured of a plurality of layers and contacts the image bearing member;
a detection unit configured to detect reflected light from a detection toner image and the belt when light is radiated to the detection toner image, which is transferred from the image bearing member to the belt, and the belt; and
a control unit configured to execute, on a basis of a detection result of the detection unit, correction control of an image formation condition of an image formed by the toner image, wherein
the plurality of layers of the belt include a first layer that has a first light transmittance and is a thickest layer out of the plurality of layers making up the belt with respect to a thickness direction of the belt and to which an ion conductive agent is added, and a second layer which has a second light transmittance lower than the first light transmittance.

2. The image forming apparatus according to claim 1, wherein
the second layer is a layer formed on an inner circumferential surface side of the belt.

3. The image forming apparatus according to claim 1, further comprising a stretching member configured to stretch the belt,
wherein
the detection unit is arranged so as to face a stretching member via the belt.

4. The image forming apparatus according to claim 3, wherein
the stretching member is a roller made of a metal member.

5. The image forming apparatus according to claim 1, wherein
the belt has a third layer that is a layer which is formed on an outer circumferential surface side of the belt and which has a third light transmittance higher than the first light transmittance, and the third layer contacts the image bearing member.

6. The image forming apparatus according to claim 5, further comprising
a cleaning member configured to contact with the third layer in a counter direction with respect to a movement direction of the belt and collects toner remaining on the belt, wherein
at a surface where the third layer is brought into contact with the cleaning member of the third layer, a plurality of grooves are formed along a movement direction of the belt.

7. The image forming apparatus according to claim 6, wherein
the grooves are periodically formed in a width direction intersecting with the movement direction.

8. The image forming apparatus according to claim 7, wherein
the plurality of grooves are periodically formed at a predetermined interval and a range of the predetermined interval is 3 μm to 50 μm.

9. The image forming apparatus according to claim 1, wherein
an electric resistance value of a surface resistivity of the belt measured from an inner circumferential surface side is lower than that of a surface resistivity of the belt measured from an outer circumferential surface side.

10. The image forming apparatus according to claim 9, wherein
the second layer is a layer to which carbon black is added.

11. The image forming apparatus according to claim 9, wherein
the second layer is a layer to which carbon nanotube is added.

12. The image forming apparatus according to claim 1, wherein
the second layer is a layer to which a phthalocyanine-based dye colorant is added.

13. The image forming apparatus according to claim 1, wherein
the detection unit includes a light emitting element which radiates infrared light to the belt and a light receiving element which receives the infrared light reflected by the belt, and
the second layer is formed only in a region of one full circumference of the belt at a position facing the detection unit in a movement direction of the belt.

14. The image forming apparatus according to claim 13, wherein
the control unit executes the correction control on a basis of reflected light from the belt, which is detected by the light receiving element, and reflected light from the detection toner image, which is detected by the light receiving element, when the infrared light is radiated from the light emitting element to the belt and the detection toner image.

15. The image forming apparatus according to claim 1, wherein
the detection unit includes a first detection member and a second detection member that are arranged so as to be opposite to each other across a center line of the belt in a width direction intersecting with a movement direction of the belt, and
the first detection member includes a light emitting element that radiates infrared light to the belt, a light receiving element that detects specularly-reflected light from the belt when the infrared light is radiated from the light emitting element to the belt, and a light receiving element that detects diffused reflected light from the belt.

16. The image forming apparatus according to claim 15, wherein
the second detection member includes a light emitting element that radiates infrared light to the belt and a light receiving element that detects diffused reflected light from the belt when the infrared light is radiated from the light emitting element to the belt, and does not include a light receiving element that detects specularly-reflected light from the belt.

17. The image forming apparatus according to claim 15, wherein
the second detection member includes a light emitting element that radiates infrared light to the belt and a light receiving element that detects specularly-reflected light from the belt when the infrared light is radiated from the light emitting element to the belt, and does not include a light receiving element that detects diffused reflected light from the belt.

18. The image forming apparatus according to claim 1, wherein
the belt is an intermediate transfer belt, and the toner image borne by the image bearing member is primarily-transferred from the image bearing member to the intermediate transfer belt and then secondarily-transferred from the intermediate transfer belt to a transfer material.

19. The image forming apparatus according to claim 1, wherein
the belt is a conveyance belt that conveys a transfer material and the toner image borne by the image bearing member is transferred to the transfer material conveyed by the conveyance belt.
